(19) United States
(12) Patent Application Publication
(10) Pub. No.: US 2018/0293904 A1
(43) Pub. Date: Oct. 11, 2018

(54) EDUCATION AND RECREATION TOOL

(71) Applicant: Hai Minh Dinh, Hanoi (VN)

(72) Inventor: Hai Minh Dinh, Hanoi (VN)

(21) Appl. No.: 16/007,603

(22) Filed: Jun. 13, 2018

Related U.S. Application Data
(63) Continuation of application No. 15/714,431, filed on Sep. 25, 2017.

(30) Foreign Application Priority Data
Nov. 9, 2016 (VN) 1201604294SC

(51) Int. Cl. G09B 1/36; A63F 9/12; A63F 9/00; A63F 9/06; A63F 3/04

(52) U.S. Cl. CPC G09B 1/36; A63F 9/1204; A63F 9/0098; A63F 2009/1248; A63F 9/1208; A63F 3/0402; A63F 2009/1232; A63F 9/0666

(57) ABSTRACT

An education and recreation tool having a main body with one or more cutouts formed on at least one surface of the main body. The tool can include multiple puzzle pieces. Each puzzle piece can be formed in a proper shape and size in order to be put fittingly into only one cutout on the main body. At least one meaningful word or image can be provided on the top surface of each puzzle piece and at least one image or meaningful word is provided on the bottom surface of each cutout to illustrate or explain the word or image on the top surface of the respective puzzle piece based on the fitting of the puzzle piece and the associated cutout.

### FIELD OF THE INVENTION

The present invention relates to an education and recreation tool, more particularly to an education and recreation tool to help “preschool-aged” children read and understand characters and meaningful words such as digits, numbers, letters, single words, compound words, phrases and sentences.

### BACKGROUND OF THE INVENTION

In order to help “preschool-aged” children in reading and playing, there are many tools provided, but some tools only help children learn letters like alphabet boards, some help children recognize words but cannot understand the meaning thereof like Glenn Doman flashcards; others do not create much enthusiasm for children to play and learn like books with printed words and images.

### SUMMARY OF THE INVENTION

A target of the present invention is to provide an education and recreation tool to help “preschool-aged” children in reading and understanding characters and meaningful words such as digits, numbers, letters, single words, compound words, phrases and sentences.

According to the first aspect of the present invention, an education and recreation tool comprises:

a main body having one or more cutouts formed in any shape and size on at least one surface of the main body;

a plurality of couples of puzzle pieces, wherein each couple of puzzle pieces are formed properly in order to be put fittingly into one or more cutouts on the main body, and each couple consists of one upper puzzle piece and one lower puzzle piece in similar shape and size; and

at least one character or image is provided on the top surface of each upper puzzle piece and at least one image or character is provided on the top surface of each lower puzzle piece to illustrate or explain the character or image on the top surface of the respective upper puzzle piece in the same couple.

According to a preferred embodiment of the first aspect of the present invention, each couple of puzzle pieces are shaped and sized properly in order to be put fittingly into only one cutout on the main body.

According to a preferred embodiment of the first aspect of the present invention, at least one custom tab and/or custom recess is provided on some or all of the puzzle pieces so that a custom tab of one puzzle piece can be interlocked into a custom recess of another puzzle piece thereby the said puzzle pieces can form any object.

According to a preferred embodiment of the first aspect of the present invention, at least one grip recess is provided at the edge of at least one cutout on the main body and/or provided on at least one puzzle piece among the upper puzzle pieces and the lower puzzle pieces thereby the said puzzle piece can be easily taken out and/or put into the respective cutout on the main body. The grip recess can be formed at the edge of a puzzle piece or completely inside the boundary line of a puzzle piece.

According to a preferred embodiment of the first aspect of the present invention, at least one knob is provided on at least one upper puzzle piece thereby the upper puzzle piece can be easily taken out and/or put into the respective cutout on the main body. The knob can be provided at any position on an upper puzzle piece.

According to another preferred embodiment of the first aspect of the present invention, at least one couple of the puzzle pieces has total thickness greater than the depth of the respective cutout, thereby the upper puzzle piece of the said couple can be easily taken out and/or put into the respective cutout on the main body.

According to the second aspect of the present invention, an education and recreation tool comprises:

a main body having one or more cutouts formed in any shape and size on at least one surface of the main body;

a plurality of puzzle pieces;

wherein each puzzle piece is formed in proper shape and size in order to be put fittingly into only one cutout on the main body;

wherein at least one meaningful word or image is provided on the top surface of each puzzle piece and at least one image or meaningful word is provided on the bottom surface of each cutout to illustrate or explain the word or image on the top surface of the respective puzzle piece put fittingly into the cutout thereof; and

wherein each puzzle piece is formed in a shape similar to the outline surrounding the word on either its top surface or the bottom surface of the cutout into which the puzzle piece is put fittingly.

According to an embodiment of the second aspect of the invention, at least one grip recess is provided at the edge of at least one cutout on the main body and/or provided on at least one puzzle piece thereby the said puzzle piece can be easily taken out and/or put into the respective cutout on the main body.

According to another embodiment of the second aspect of the invention, at least one knob is provided on at least one puzzle piece thereby the said puzzle piece can be easily taken out and/or put into the respective cutout on the main body.

According to yet another embodiment of the second aspect of the invention, at least one puzzle piece has thickness greater than the depth of the respective cutout, thereby the said puzzle piece can be easily taken out and/or put into the respective cutout on the main body.

According to the third aspect of the present invention, the education and recreation tool comprises:

a main body having one or more cutouts formed in any shape and size on at least one surface of the main body;

a plurality of puzzle pieces;

wherein each puzzle piece is formed in proper shape and size in order to be put fittingly into only one cutout on the main body;

wherein at least one meaningful word or image is provided on the top surface of each puzzle piece and at least one image or meaningful word is provided on the bottom surface of each cutout to illustrate or explain the word or image on the top surface of the respective puzzle piece put fittingly into the cutout thereof; and

wherein at least one custom tab and/or custom recess is provided on some or all of the puzzle pieces so that the custom tab of one puzzle piece can be interlocked into the custom recess of another puzzle piece thereby the said puzzle pieces can be associated to form any object.

According to a preferred embodiment of the third aspect of the invention, at least one grip recess is provided at the edge of at least one cutout on the main body and/or provided on at least one puzzle piece thereby the said puzzle piece can be easily taken out and/or put into the respective cutout on the main body.

According to another embodiment of the third aspect of the invention, at least one knob is provided on at least one puzzle piece thereby the said puzzle piece can be easily taken out and/or put into the respective cutout on the main body.

According to yet another embodiment of the third aspect of the invention, at least one puzzle piece has thickness greater than the depth of the respective cutout, thereby the said puzzle piece can be easily taken out and/or put into the respective cutout on the main body.

The present invention provides a puzzle game, an interesting game for “preschool-aged” children. Children can play when they can sit themselves. They play by holding, then putting the puzzle pieces into and/or taking them out of the cutouts on the main body. At first times of playing, children play with support from a trainer. Subsequently, they can play themselves. When playing, each time children see characters or meaningful words such as a number, a word, a phrase or a sentence on the top surface of a puzzle piece or on the bottom surface of a cutout, the trainer would read them out loudly and clearly, thereby children will know how to pronounce them.

Furthermore, the playing process also helps children recognize and remember the characters and the related images. Children will understand the relationship between the characters and the related images basing on the similarity in shape and size of the puzzle pieces and the respective cutouts, including the fitting of the puzzle pieces into the respective cutouts. Moreover, according to another preferred method, in order to further help children recognize the above relationship, the present invention utilizes colors as similar signals on objects containing images and on objects containing characters. For example, yellow characters forming the word “table” on the top surface of a puzzle piece and an “image of a yellow table” on the top surface of the other puzzle piece in the same couple. Children can correctly put the puzzle pieces, basing on the recognition of the similarity in colors, into the respective cutouts, thereby understand the relationship between the characters and the related images. In order to help children avoid confusion between the images and the characters, there should be only images or only characters on the top surface of one puzzle piece or the bottom surface of one cutout and vice versa. When children know how to pronounce, remember characters and related images, they would know how to read and understand numbers, words, phrases and sentences.

In the second aspect of the present invention, an important feature is that the similarity between the shape of a puzzle piece and the shape of the word on either its top surface or the bottom surface of the cutout into which the puzzle piece is put fittingly. This feature helps children learn and remember words more easily and quickly. The reason is that, children are sensitive to shapes and images, they can easily and quickly recognize a small difference between two items if any as well as they can easily and quickly recognize the similarity of two items if any. The above similarity helps children recognize the relationship between the puzzle piece and the relevant word. Thanks to the similarity, during playing time, whenever children see a puzzle piece or a cutout, they will think of the relating word. To some extend, children can call up the word on the top surface of a puzzle piece even if the puzzle piece is upside-down.

Additionally, the language learning process helps children boost their logical thinking, develop their personality, promote their communication skills, fasten their family relations, strengthen their ability in recognizing colors and shapes, and achieve more general knowledge. The action of holding the puzzle pieces to put into and/or take out of the cutouts on the main body also helps children practice their ability of holding entities. In order for children to develop good personality, any discriminatory or violent words should not be included on the top surface of the puzzle pieces or the bottom surface of the cutout.

### BRIEF DESCRIPTION OF THE DRAWINGS

FIG. 1 is a perspective view of a part of the education and recreation tool according to a preferred embodiment of the first aspect of the present invention;

FIG. 2 is a perspective view of the education and recreation tool according to another preferred embodiment of the first aspect of the present invention; and

FIG. 3 is another perspective view of the education and recreation tool of the preferred embodiment shown in FIG. 2.

FIG. 4 is a perspective view of the education and recreation tool according to the second aspect of the present invention;

FIG. 5 is a perspective view of the education and recreation tool according to the third aspect of the present invention; and

FIG. 6 is a perspective view of the education and recreation tool of the third aspect shown in FIG. 5 in which its puzzle pieces associated together to form one sport-utility vehicle.

### DETAILED DESCRIPTION OF THE PREFERRED EMBODIMENTS

In the following description, the preferred embodiments are described with reference to the accompanying drawings. It should be understood, however, that these embodiments, drawings and detail description are not intended to limit the scope of the present invention. It will be understood by those of ordinary skill in the art that various modifications and changes of the education and recreation tool can be made without departing from the spirit or scope of the present invention. Therefore, it should be understood that the present invention includes these modifications and changes. The present invention is to be considered limited solely by the scope of the appended claims.

Besides, English single words are used as exemplifications in preferred embodiments and drawings of the present invention. However it should be understood that the present invention can be applied to any language as well as to characters and meaningful words such as digits, numbers, letters, single words, compound words, phrases and sentences.

In the drawings, details which are identical or similar are indicated by the same reference numbers. Likewise, the shape of the puzzle pieces and/or the main body in one embodiment can be used for other embodiments and vice versa.

According to the first aspect of the present invention, the education and recreation tool comprises:

a main body in shape of a flat board or of any cube having one or more cutouts formed in any shape and size on at least one surface of the main body;

a plurality of couples of puzzle pieces, wherein each couple of puzzle pieces are formed properly in order to be put fittingly into one or more cutouts on the main body, and each couple consists of one upper puzzle piece and one lower puzzle piece in similar shape and size; and

at least one character or image is provided on the top surface of each upper puzzle piece and at least one image or character is provided on the top surface of each lower puzzle piece to illustrate or explain the character or image on the top surface of the respective upper puzzle piece in the same couple. The number of the puzzle pieces can be less or more than the number of the cutouts on the main body.

According to a preferred embodiment of the first aspect of the present invention, each couple of puzzle pieces are shaped and sized properly in order to be put fittingly into only one cutout on the main body.

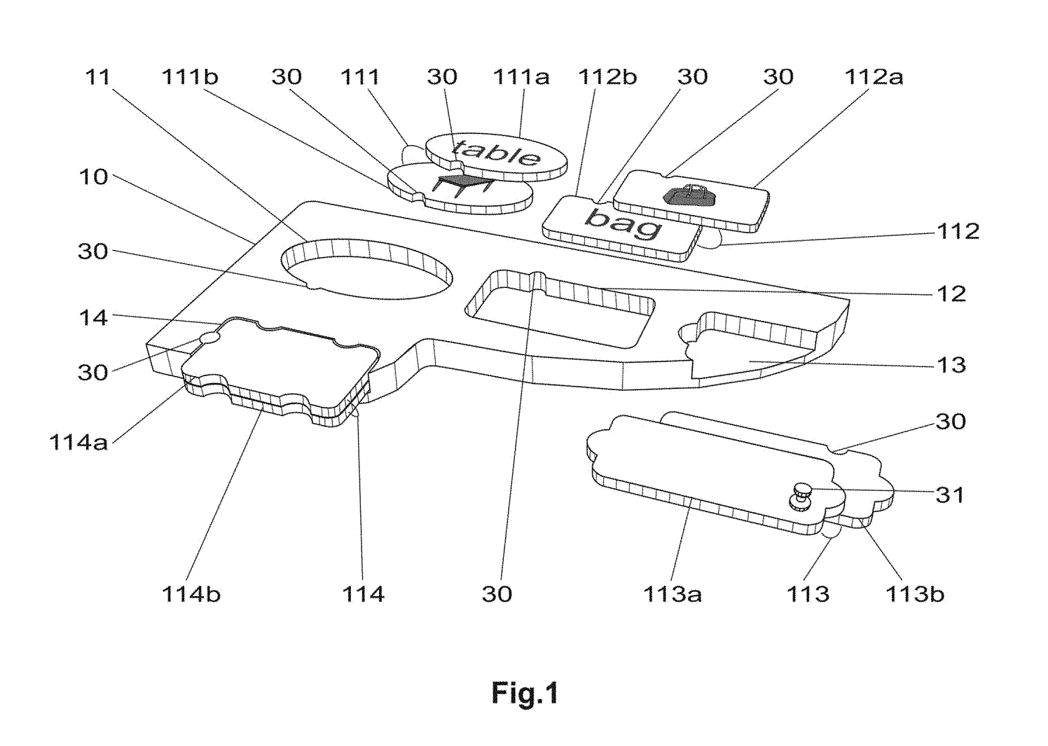

FIG. 1 is a perspective view of a preferred exemplified embodiment of the first aspect of the present invention, wherein the main body 10 is in shape of a flat board with four cutouts 11, 12, 13, 14 formed on the top surface of the main body and four couples of puzzle pieces 111, 112, 113, 114, respectively. However, the present number of the cutouts and the couples of puzzle pieces is not limited to four as described above, any desired number of cutouts and couples of puzzle pieces can be used.

Each couple of puzzle pieces 111, 112, 113, 114 consists of one upper puzzle piece 111a, 112a, 113a, 114a and one lower puzzle piece 111b, 112b, 113b, 114b respectively in similar shape and size. The shape and the size of each couple of puzzle pieces 111, 112, 113, 114 are similar to those of one cutout 11, 12, 13, 14 respectively, so that each couple of puzzle pieces 111, 112, 113, 114 can be put fittingly into only one cutout 11, 12, 13, 14, respectively.

At least one character or image is provided on the top surface of each upper puzzle piece 111a, 112a, 113a, 114a and at least one image or character is provided on the top surface of each lower puzzle piece 111b, 112b, 113b, 114b to illustrate or explain the character or image on the top surface of the respective upper puzzle piece 111a, 112a, 113a, 114a in the same couple. For example, as shown in FIG. 1, the couple of puzzle pieces 111 consists of one upper puzzle piece 111a and one lower puzzle piece 111b. On the top surface of the upper puzzle piece 111a there are characters forming the word “table”, and on the top surface of the lower puzzle piece 111b there is an “image of a table” to illustrate the above word “table”. And the couple of puzzle pieces 112 consists of one upper puzzle piece 112a and one lower puzzle piece 112b. On the top surface of the upper puzzle piece 112a there is an “image of a bag”, and on the top surface of the lower puzzle piece 112b there are characters forming the word “bag” to explain the above “image of a bag”.

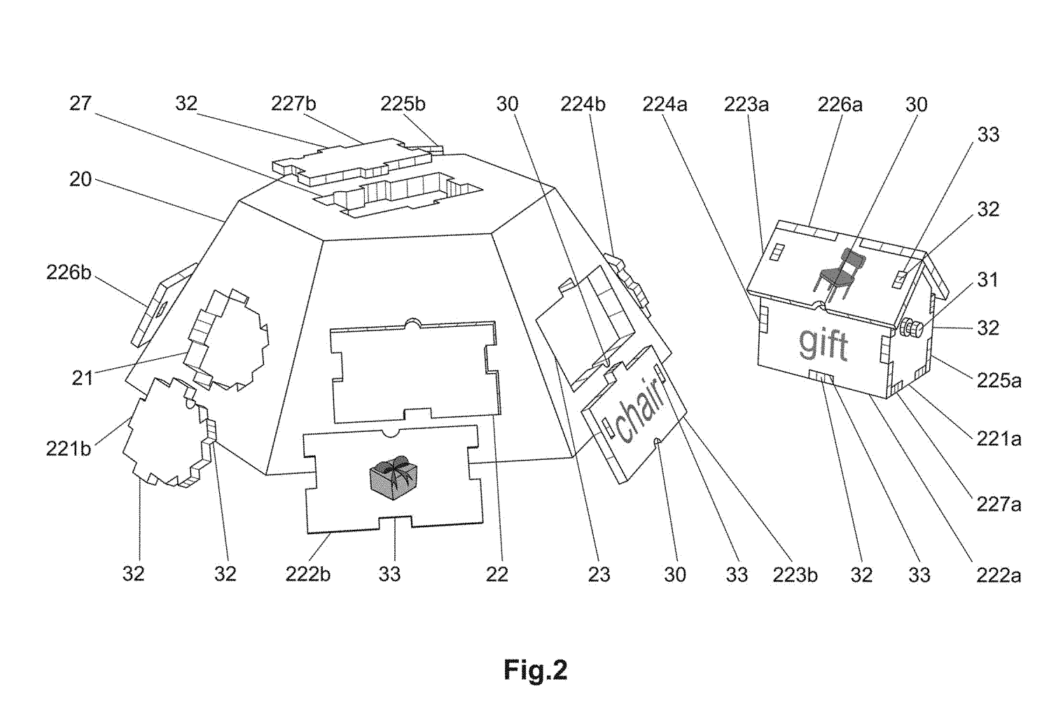

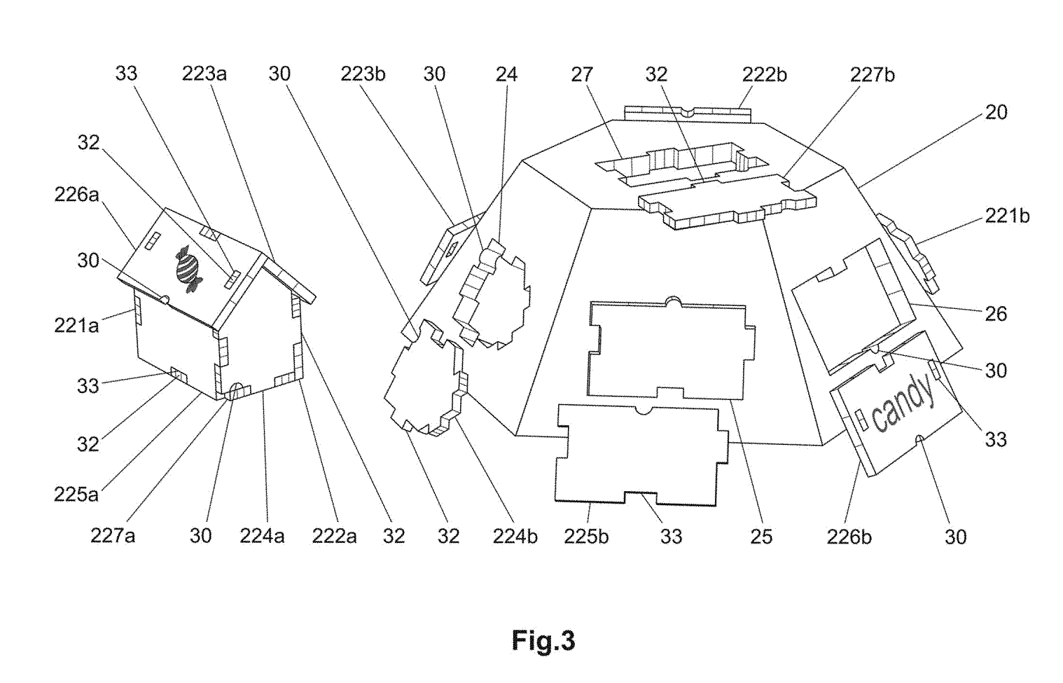

FIG. 2 and FIG. 3 are two different perspective views of the education and recreation tool according to another preferred embodiment to further illustrate the first aspect of the present invention, wherein the main body 20 is in shape of a cube. As shown in FIG. 2 and FIG. 3, there are seven cutouts 21, 22, 23, 24, 25, 26, 27 in any shape and size formed on seven surfaces of the main body 20 and seven couples of puzzle pieces 221, 222, 223, 224, 225, 226, 227 respectively. Each couple of puzzle pieces 221, 222, 223, 224, 225, 226, 227 consists of one upper puzzle piece 221a, 222a, 223a, 224a, 225a, 226a, 227a and one lower puzzle piece 221b, 222b, 223b, 224b, 225b, 226b, 227b respectively. However, the present number of the cutouts and the couples of puzzle pieces is not limited to seven as described above, any desired number of the cutouts and the couples of puzzle pieces can be used.

The cutouts 21, 22, 23, 24, 25, 26, 27 are formed in different shapes so that, when being stacked upon each other, no shape is contained by or matched to any other shape completely, i.e no shape falls across or insert to any other shape. Shape and size of each couple of puzzle pieces 221, 222, 223, 224, 225, 226, 227 are similar to those of one cutout 21, 22, 23, 24, 25, 26, 27 respectively, so that each couple of the puzzle pieces 221, 222, 223, 224, 225, 226, 227 can be put fittingly into only one cutout 21, 22, 23, 24, 25, 26, 27, respectively.

According to this embodiment, at least one character or image is provided on the top surface of each upper puzzle piece 221a, 222a, 223a, 224a, 225a, 226a, 227a, and at least one image or character is provided on the top surface of each lower puzzle piece 221b, 222b, 223b, 224b, 225b, 226b, 227b to illustrate or explain the character or image on the top surface of the respective upper puzzle piece 221a, 222a, 223a, 224a, 225a, 226a, 227a in the same couple.

For example, as shown in FIG. 2, the couple of puzzle pieces 222 consists of one upper puzzle piece 222a and one lower puzzle piece 222b. On the top surface of the upper puzzle piece 222a there are characters forming the word “gift”, and on the top surface of the lower puzzle piece 222b there is an “image of a gift” to illustrate the above word “gift”. And the couple of puzzle pieces 223 consists of one upper puzzle piece 223a and one lower puzzle piece 223b. On the top surface of the upper puzzle piece 223a there is an “image of a chair”, and on the top surface of the lower puzzle piece 223b there are characters forming the word “chair” to explain the above “image of a chair”. And as shown in FIG. 3, the couple of puzzle pieces 226 consists of one upper puzzle piece 226a and one lower puzzle piece 226b. On the top surface of the upper puzzle piece 226a there is an “image of a candy”, and on the top surface of the lower puzzle piece 226b there are characters forming the word “candy” to explain the above “image of a candy”.

According to this embodiment, some or all of the puzzle pieces can be interlocked together to form an object such as a house, a box, a wardrobe, a car, a table, a chair or any object depending on the designer.

In order to form an object, some or all of the puzzle pieces not only have proper shape and size but also have at least one custom tab 32 and/or custom recess 33 which are properly designed so that a custom tab 32 of one puzzle piece can be interlocked into a custom recess 33 of another puzzle piece thereby the said puzzle pieces would form the object. As shown in FIG. 2 and FIG. 3, the custom tab 32 is formed at the edge of a puzzle piece such as on the puzzle piece 221a, 221b, 224a, 224b, 227a, 227b, while the custom recess 33 can be formed at the edge of a puzzle piece such as on the puzzle piece 222a, 222b, 225a, 225b or formed completely inside the boundary line of a puzzle piece such as on the puzzle piece 223a, 223b, 226a, 226b.

For example, as shown in FIG. 2 and FIG. 3, upper puzzle pieces 221a, 222a, 223a, 224a, 225a, 226a, 227a are interlocked together to form a house, wherein two puzzle pieces 223a and 226a are two roofs of the house, upper puzzle piece 227a is the floor of the house and four upper puzzle pieces 221a, 222a, 224a, 225a are four walls of the house.

As shown in FIG. 1 to FIG. 3, at least one grip recess 30 is provided on the edge of at least one puzzle piece among the upper puzzle pieces and the lower puzzle pieces. However, alternatively, the grip recess 30 can be formed completely inside the boundary line of a puzzle piece (which are not shown in the drawings). Moreover, at least one knob 31 is provided at any position on at least one upper puzzle piece. The grip recess 30 and the knob 31 are of proper size thereby the upper puzzle piece can be easily taken out and/or put into the respective cutout on the main body. According to a preferred embodiment of the present invention, all upper puzzle pieces and lower puzzle pieces have at least one grip recess 30 at the edge of the puzzle pieces.

The grip recess 30 can be formed partly deep into the thickness or through the whole thickness of a puzzle piece. In case both the upper puzzle piece and the lower puzzle piece in the same couple have at least one grip recess 30, it is preferred that the grip recess 30 on the upper puzzle piece and the grip recess 30 on the lower puzzle piece in the same couple are formed at the same position such as the couples 111 and 112 shown in FIG. 1.

Moreover, in case at least one grip recess 30 is provided at the edge of any upper puzzle piece or lower puzzle piece, optionally, at the edge of the respective cutout on the main body into which the said puzzle piece is supposed to be put, there is also a grip recess 30 at such a position that when the upper puzzle piece or the lower puzzle piece is put fittingly into the cutout, the grip recess 30 at the edge of the upper puzzle piece or the lower puzzle piece would match with the grip recess 30 at the edge of the cutout to form a complete hole. It is preferred that both the upper puzzle piece and the lower puzzle piece in the same couple have a grip recess 30 formed at the same position at the edge of each puzzle piece like the upper puzzle piece and the lower puzzle piece of the couple 114 to be put into the cutout 14 as shown in FIG. 1.

According to a preferred embodiment of the first aspect of the present invention, at the edge of at least one cutout on the main body, there is at least one grip recess 30, while there is no grip recess 30 on the upper puzzle pieces and the lower puzzle pieces (which are not shown in the drawings).

According to a preferred embodiment of the first aspect of the present invention, encrusted characters or images, or sculpted characters or images (which are not shown in the drawings) are provided on the top surface of at least one puzzle piece among the upper puzzle pieces and the lower puzzle pieces, thereby the said puzzle piece can be easily taken out and/or put into the respective cutout on the main body.

According to a preferred embodiment of the first aspect of the present invention, at least one couple of the puzzle pieces have total thickness greater than the depth of the respective cutout, thereby the upper puzzle piece of the said couple can be easily taken out and/or put into the respective cutout on the main body.

According to a preferred embodiment of the first aspect of the present invention, the cutouts on the main body are formed in different shapes so that, when being stacked upon each other, no shape is contained by or matched to any other shape completely, i.e no shape falls across or inserts to any other shape, thereby each couple of puzzle pieces can be put fittingly into only one cutout on the main body. This would help children not to confuse the relationship between images and characters on the couple of the puzzle pieces.

According to another preferred embodiment of the first aspect of the present invention, among the couples of puzzle pieces, many couples of puzzle pieces of the same shape and size can be provided thereby they can be put fittingly into the same cutout, but characters and images on different couples of puzzle pieces are different.

In the present invention, shapes of the cutouts and respective couples of puzzle pieces can be ellipses, rectangles, squares, circles, triangles, car-shapes, tree-shapes, or any shapes.

In the present invention, shapes applied to the cutouts and the puzzle pieces of the embodiment shown in FIG. 2 and FIG. 3 can be applied to the cutouts and the puzzle pieces of the embodiment shown in FIG. 1, and vice versa. Accordingly, some or all of the puzzle pieces of the embodiment shown in FIG. 1 can also be interlocked together to form any object. According to the second aspect of the present invention, the education and recreation tool comprises:

a main body, in shape of a flat board or of any cube, having one or more cutouts formed in any shape and size on at least one surface of the main body;

a plurality of puzzle pieces;

wherein each puzzle piece is formed in proper shape and size in order to be put fittingly into only one cutout on the main body;

wherein at least one meaningful word or image is provided on the top surface of each puzzle piece and at least one image or meaningful word is provided on the bottom surface of each cutout to illustrate or explain the word or image on the top surface of the respective puzzle piece put fittingly into the cutout thereof; and

wherein each puzzle piece is formed in a shape similar to the outline surrounding the word on either its top surface or the bottom surface of the cutout into which the puzzle piece is put fittingly, it means that the shape of a puzzle piece is similar to the shape of the word thereof.

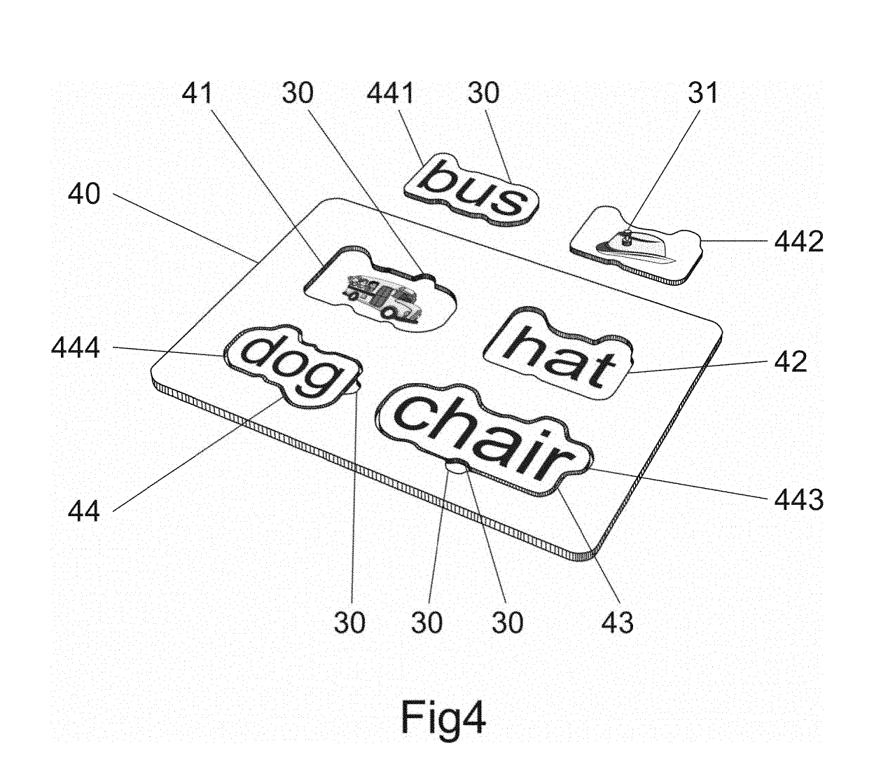

FIG. 4 is a perspective view of a preferred exemplified embodiment according to the second aspect of the present invention, wherein the main body 40 is in shape of a flat board with four cutouts 41, 42, 43, 44 formed on the top surface of the main body and four puzzle pieces 441, 442, 443, 444, respectively. However, the present number of the cutouts and the puzzle pieces is not limited to four as described above, any desired number of cutouts and puzzle pieces can be used.

The shape and the size of each puzzle piece 441, 442, 443, 444 are similar to those of one cutout 41, 42, 43, 44 respectively, so that each puzzle piece 441, 442, 443, 444 can be put fittingly into only one cutout 41, 42, 43, 44 respectively.

At least one meaningful word or image is provided on the top surface of each puzzle piece 441, 442, 443, 444 and at least one image or meaningful word is provided on the bottom surface of each cutout 41, 42, 43, 44 to illustrate or explain the word or image on the top surface of the respective puzzle piece 441, 442, 443, 444 put fittingly into the cutout thereof. For example, as shown in FIG. 4, on the top surface of the puzzle piece 441 there is the word “bus”, and on the bottom surface of the cutout 41 there is an “image of a bus” to illustrate the above word “bus”. And on the top surface of the puzzle piece 442 there is an “image of a hat”, and on the bottom surface of the cutout 42 there is the word “hat” to explain the above “image of a hat”.

The shape of puzzle piece 441 is similar to the outline surrounding the word “bus” on its top surface, therefore it is similar to the shape of the word “bus”. The shape of puzzle piece 442 is similar to the outline surrounding the word “hat” on the bottom surface of the cutout 42 into which the puzzle piece 442 is put fittingly, therefore it is similar to the shape of the word “hat”. The shape of puzzle piece 443 is similar to the outline surrounding the word “chair” on its top surface, therefore it is similar to the shape of the word “chair”. And the shape of puzzle piece 444 is similar to the outline surrounding the word “dog” on its top surface, therefore it is similar to the shape of the word “dog”.

According to the third aspect of the present invention, the education and recreation tool comprises:

a main body, in shape of a flat board or of any cube, having one or more cutouts formed in any shape and size on at least one surface of the main body;

a plurality of puzzle pieces;

wherein each puzzle piece is formed in proper shape and size in order to be put fittingly into only one cutout on the main body;

wherein at least one meaningful word or image is provided on the top surface of each puzzle piece and at least one image or meaningful word is provided on the bottom surface of each cutout to illustrate or explain the word or image on the top surface of the respective puzzle piece put fittingly into the cutout thereof; and

wherein at least one custom tab and/or custom recess is provided on some or all of the puzzle pieces so that the custom tab of one puzzle piece can be interlocked into the custom recess of another puzzle piece thereby the said puzzle pieces can be associated to form any object.

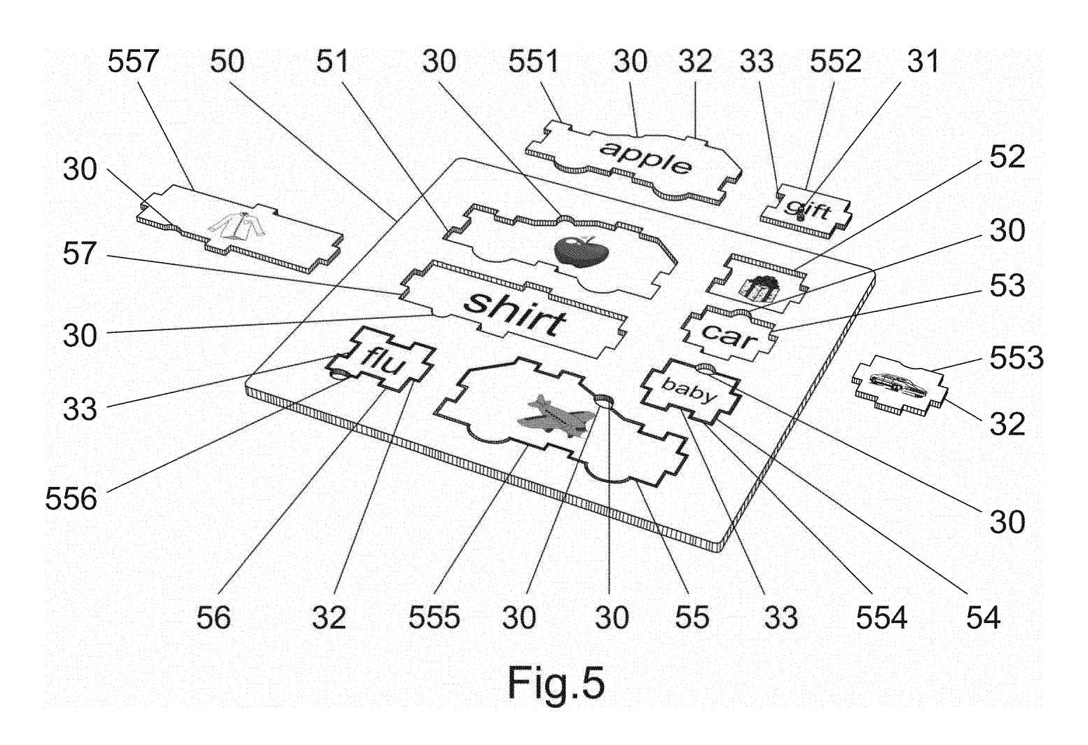

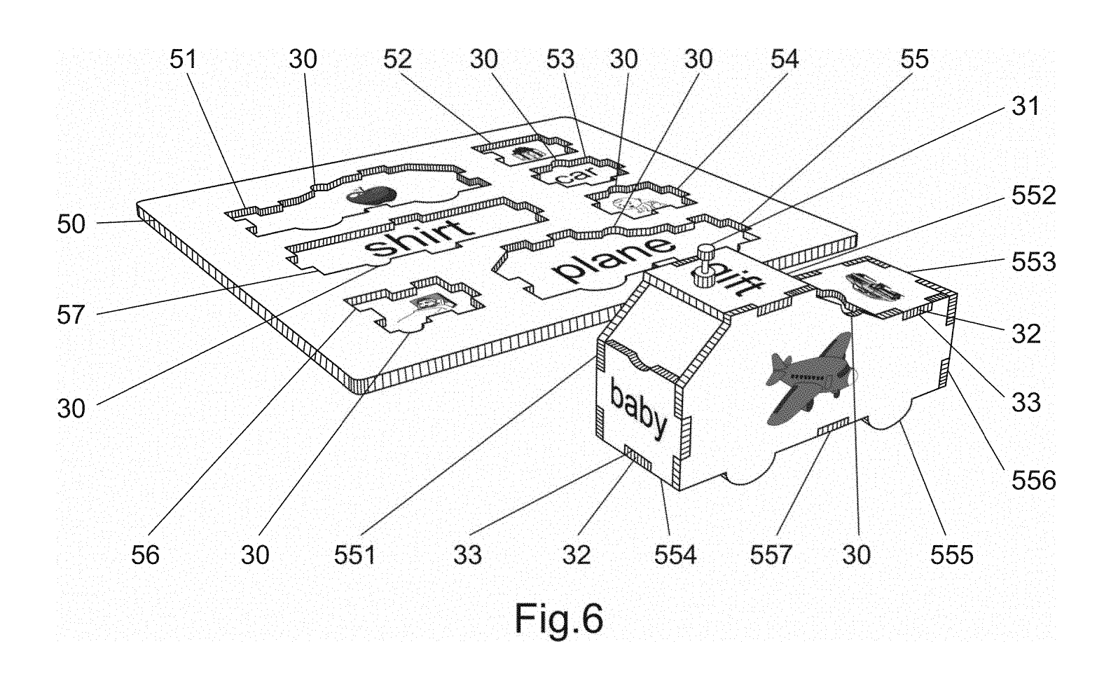

FIG. 5 and FIG. 6 are two different perspective views of a preferred exemplified embodiment according to a third aspect of the present invention, wherein the main body 50 is in shape of a flat board. As shown in FIG. 5 and FIG. 6, there are seven cutouts 51, 52, 53, 54, 55, 56, 57 in any shape and size formed on the top surface of the main body 50 and seven puzzle pieces 551, 552, 553, 554, 555, 556, 557 respectively. However, the present number of the cutouts and the puzzle pieces is not limited to seven as described above, any desired number of the cutouts and the puzzle pieces can be used.

Shape and size of each puzzle piece 551, 552, 553, 554, 555, 556, 557 are similar to those of one cutout 51, 52, 53, 54, 55, 56, 57 respectively, so that each puzzle piece 551, 552, 553, 554, 555, 556, 557 can be put fittingly into only one cutout 51, 52, 53, 54, 55, 56, 57, respectively.

At least one meaningful word or image is provided on the top surface of each puzzle piece 551, 552, 553, 554, 555, 556, 557, and at least one image or meaningful word is provided on the bottom surface of each cutout 51, 52, 53, 54, 55, 56, 57 to illustrate or explain the word or image on the top surface of the respective puzzle piece 551, 552, 553, 554, 555, 556, 557 put fittingly into the cutout thereof.

For example, as shown in FIG. 5, on the top surface of the puzzle piece 552 there is the word “gift”, and on the bottom surface of the cutout 52 there is an “image of a gift” to illustrate the above word “gift”. And on the top surface of the puzzle piece 553 there is an “image of a car”, and on the bottom surface of the cutout 53 there is the word “car” to explain the above “image of a car”.

According to a preferred embodiment of the third aspect, some or all of the puzzle pieces can be interlocked together to form an object such as a house, a box, a wardrobe, a vehicle, a table, a chair or any object depending on the designer.

In order to form an object, some or all of the puzzle pieces not only have proper shape and size but also have at least one custom tab 32 and/or custom recess 33 which are properly designed so that the custom tab 32 of one puzzle piece can be interlocked into the custom recess 33 of another puzzle piece thereby the said puzzle pieces would be associated to form the object.

As shown in FIG. 5 and FIG. 6, the custom tab 32 is formed at the edge of a puzzle piece, while the custom recess 33 can be formed at the edge of a puzzle piece or formed completely inside the boundary line of a puzzle piece (which are not shown in the drawings).

As shown in FIG. 6, puzzle pieces 551-557 are interlocked together to form one sport-utility vehicle.

According to an embodiment of the second and third aspect of the present invention, the number of the puzzle pieces can be less or more than the number of the cutouts on the main body.

According to an embodiment of the second and third aspect of the present invention, as shown in FIG. 4, FIG. 5 and FIG. 6, at least one grip recess 30 is provided on the edge of at least one puzzle piece. However, alternatively, the grip recess 30 can be formed completely inside the boundary line of a puzzle piece (which are not shown in the drawings). The grip recess 30 can be formed partly deep into the thickness or through the whole thickness of a puzzle piece. It is preferred that each of puzzle pieces has at least one grip recess 30 at their edge.

According to an embodiment of the second and third aspect of the present invention, at least one knob 31 can be provided at any position on at least one puzzle piece in which the grip recess 30 may or may not be provided.

The grip recess 30 and the knob 31 are of proper size thereby the puzzle piece can be easily taken out and/or put into the respective cutout on the main body.

According to an embodiment of the second and third aspect of the present invention, in case at least one grip recess 30 is provided at the edge of any puzzle piece, optionally, at the edge of the respective cutout on the main body into which the said any puzzle piece is put fittingly, there is also a grip recess 30 at such a position that when the said any puzzle piece is put fittingly into the cutout thereof, the grip recess 30 at the edge of the puzzle piece would match with the grip recess 30 at the edge of the cutout thereof to form a larger complete hole. For example, the complete holes are formed by the grip recesses 30 of the puzzle piece 443 and the cutout 43 thereof in FIG. 4.

According to an embodiment of the second and third aspect of the present invention, at the edge of at least one cutout on the main body, there is at least one grip recess 30, while there is no grip recess 30 on the puzzle piece, for example, in the case of grip recess 30 of the cutout 44 in FIG. 4.

According to an embodiment of the second and third aspect of the present invention, encrusted words or images, or sculpted words or images (which are not shown in the drawings) are provided on the top surface of at least one puzzle piece, thereby the said puzzle piece can be easily taken out and/or put into the respective cutout on the main body.

According to an embodiment of the second and third aspect of the present invention, at least one puzzle piece has thickness greater than the depth of the respective cutout thereof, thereby the said puzzle piece can be easily taken out and/or put into the respective cutout on the main body.

According to an embodiment of the second and third aspect of the present invention, the cutouts on the main body are formed in different shapes so that, if being stacked upon each other, no shape is contained by or matched to any other shape completely, i.e no shape falls across or inserts to any other shape, thereby it is possible to ensure that each puzzle piece can be put fittingly into only one cutout on the main body. This would help children not to confuse the relationship between images and meaningful words on the top surface of the puzzle pieces and the bottom surface of the cutouts and vice versa.

In this description, the term “cube” means a three-dimensional object such as a polygon, a sphere, a semi-sphere, or any three-dimensional object that is proportionate or not. In this description, the characters and the images on the top surfaces of the puzzle pieces can be encrusted, sculpted, printed or drawn directly on these surfaces, or are cut, shaped, encrusted, sculpted, printed or drawn on other materials such as paper, nylon, plastic, wood, etc, then stuck on these top surfaces.

What is claimed is:

1. An education and recreation tool, comprising:
a main body having one or more cutouts formed in any shape and size on at least one surface of the main body;
a plurality of puzzle pieces;
wherein each puzzle piece is formed in proper shape and size in order to be put fittingly into only one cutout on the main body;
wherein at least one meaningful word or image is provided on the top surface of each puzzle piece and at least one image or meaningful word is provided on the bottom surface of each cutout to illustrate or explain the word or image on the top surface of the respective puzzle piece put fittingly into the cutout thereof; and
wherein each puzzle piece is formed in a shape similar to the outline surrounding the word on either its top surface or the bottom surface of the cutout into which the puzzle piece can be put fittingly.

2. The education and recreation tool according to claim 1, wherein at least one grip recess is provided at the edge of at least one cutout on the main body and/or provided on at least one puzzle piece thereby the said puzzle piece can be easily taken out and/or put into the respective cutout on the main body.

3. The education and recreation tool according to claim 1, wherein at least one knob is provided on at least one puzzle piece thereby the said puzzle piece can be easily taken out and/or put into the respective cutout on the main body.

4. The education and recreation tool according to claim 1, wherein at least one puzzle piece has thickness greater than the depth of the respective cutout, thereby the said puzzle piece can be easily taken out and/or put into the respective cutout on the main body.

5. An education and recreation tool, comprising:
a main body having one or more cutouts formed in any shape and size on at least one surface of the main body;
a plurality of puzzle pieces;
wherein each puzzle piece is formed in proper shape and size in order to be put fittingly into only one cutout on the main body;
wherein at least one meaningful word or image is provided on the top surface of each puzzle piece and at least one image or meaningful word is provided on the bottom surface of each cutout to illustrate or explain the word or image on the top surface of the respective puzzle piece put fittingly into the cutout thereof; and
wherein at least one custom tab and/or custom recess is provided on some or all of the puzzle pieces so that the custom tab of one puzzle piece can be interlocked into the custom recess of another puzzle piece thereby the said puzzle pieces can be associated to form any object.

6. The education and recreation tool according to claim 5, wherein at least one grip recess is provided at the edge of at least one cutout on the main body and/or provided on at least one puzzle piece thereby the said puzzle piece can be easily taken out and/or put into the respective cutout on the main body.

7. The education and recreation tool according to claim 5, wherein at least one knob is provided on at least one puzzle piece thereby the said puzzle piece can be easily taken out and/or put into the respective cutout on the main body.

8. The education and recreation tool according to claim 5, wherein at least one puzzle piece has thickness greater than the depth of the respective cutout, thereby the said puzzle piece can be easily taken out and/or put into the respective cutout on the main body.
